(19) United States
(12) Patent Application Publication
(10) Pub. No.: US 2004/0185884 A1
(43) Pub. Date: Sep. 23, 2004

(54) Base station resource management and a base station

(76) Inventors: Jukka Marin, Espoo (FI); Tuomo Flystrom, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/481,760

(22) PCT Filed: Jul. 1, 2002
(86) PCT No.: PCT/FI02/00583

(30) Foreign Application Priority Data
Jun. 29, 2001 (FI) 20011424

(51) Int. Cl. H04Q 7/20

(52) U.S. Cl. 455/466

(57) ABSTRACT

The invention concerns a base station, a cellular network and a method for managing resources in a cellular radio network having a base station forming at least a first cell (CELL#1) and a second cell (CELL#4), the method comprising having a predetermined first set of hardware resource (HW1) at the base station, having a predetermined second set of hardware resource (HW2) at the base station, providing fixedly resource from the first set of hardware resource (HW1) to the first cell (CELL#1), and providing fixedly resource from the second set of hardware resource (HW2) to the second cell (CELL#4).

The present invention relates to base station resource management and a base station.

Networks of cellular systems are typically divided into a Radio Access Network RAN and a Core Network CN. Presently the third generation (3G) radio systems are being standardized. One 3G system will be based on WCDMA technology, Wide-band Code Division Multiple Access, over the air interface and thus this technology will be used in the RAN, whereas the CN will be similar to the one existing in GSM (Global System for Mobile communications).

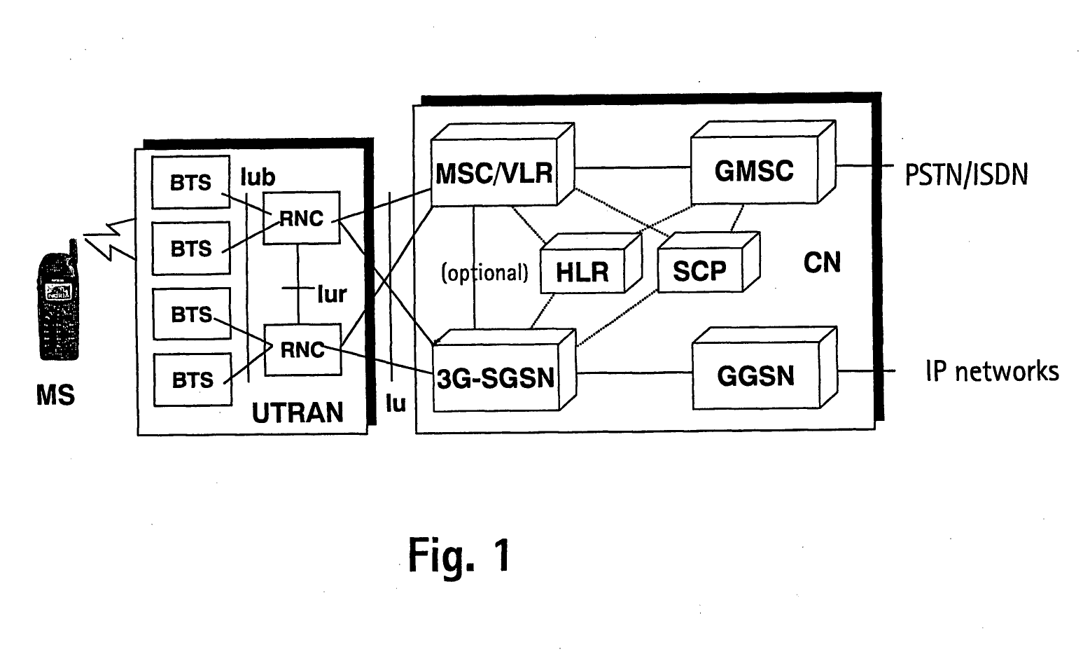

FIG. 1 presents a block diagram of the system architecture of a 3G system. The system comprises the elements shown in FIG. 1, i.e. a mobile station MS, the RAN (marked UTRAN, UMTS Terrestrial RAN where UMTS stands for Universal Mobile Telecommunications System), and the CN. The mobile station MS is radio connected to at least one base station BTS which is connected to a radio network controller (RNC) over the so called lub interface (and two RNCs may be connected with each other over the so called lur interface). Further the RAN is connected to the CN over the lu interface. As shown in the figure the RNC is connected to the MSC (Mobile services Switching Centre) including the VLR (Visitor Location Register) and to the SGSN (Service GPRS Support Node, where GPRS is General Packet Radio Service that is standardized in GSM). Further the SGSN is connected to the GGSN (Gateway GPRS Support Node) and the MSC is connected to the GMSC (Gateway MSC). As seen in the figure at least the MSC, GMSC and SGSN have a connection to the HLR (Home Location Register) and SCP (Service Control Point). The connection to other networks go via the GMSC and the GGSN, where typically circuit switched communication would go via the MSCs (i.e. via the MSC and GMSC) and packet switched communication would go via the GSNs (i.e. via the SGSN and GGSN).

The radio frequencies that the 3G system (that will be based on WCDMA, Wide-band Code Division Multiple Access) will use (in communication between the MS and the BTS) have been agreed by different standardization bodies, and in several countries licenses to build 3G networks have been sold to operators on auctions. These licenses have been tremendously expensive. Also building up a new network additionally requires huge investments to be made on equipment and there therefore exists questions how the operators will be able to make profit and pay off the investments with the 3G system. Moreover, in certain countries there has been given a requirement of a certain (minimum) coverage area in order for the operator to get the 3G network license.

Therefore there is a clear need to seek solutions for saving costs in relation to these new networks. One solution to this is sharing of a radio access network (RAN) between at least two different operators. Such a solution has been presented in an earlier Finnish patent application Fl 20010483 by Nokia (not yet public on the priority date of the present application), which proposes to share a radio network controller (RNC) and/or a base station (BTS) between two different core networks. In an example the two different core networks can be part of two different (but of the same type) cellular networks (such as 3G networks). There has been proposed that the two different core networks can belong to two different network operators. In sharing a base station the Finnish patent application discloses that at a shared base station different cells would be established whereby different operators would have different cells and thereby each operator sharing a base station would have own cells.

By sharing base stations between different operators subscribers of different operators are able to utilize the same radio access network and when the number of subscribers increase the operators may slowly start building overlapping networks to meet the demand, and after a while the co-operating operators may have two fully independent networks, i.e. fully own base stations. However, by two or more operators co-operating in the beginning of the life time of a new network, smaller investments can be made, but still the operators are able to offer a good geographical coverage and have sufficient capacity for the subscribers. Thereby the operators are able to keep the investments on a level where there is directly a good number of paying customers (subscribers) to generate income in relation to the investments made.

This is also a benefit to the subscribers as the operators will be able to keep the service prices on a lower level in that they are not required to build up a completely independent network in the beginning. No expensive roaming is therefore needed as the subscribers may move within the geographical area but during the whole time being served by his/her own operator. This can be compared to the situation presently in the United States where certain operators only cover certain States and if the subscriber moves to a particular State the mobile telephone roames to the network of another operator and the roaming phone calls are presently very expensive. Building networks for bigger geographical areas by shared base stations will help avoid such problems in new networks.

Sharing a base station between two different operators, however, raises the problem of allocating base station resources, in particular the hardware resources, which affect the processing capability of the base station. If this is not considered, but the base station is operated as a regular unshared base station, then the internal hardware resources of a base station are allocated based on contention, whereby one of the operators sharing a base station might not get the base station internal processing capacity (internal hardware resource) as needed.

According to a first aspect of the invention there is provided a method for managing resources in a cellular radio network having a base station forming at least a first cell and a second cell, the method comprising

having a predetermined first set of hardware resource at the base station,

having a predetermined second set of hardware resource at the base station;

providing fixedly transport channel processing resource from the first set of hardware resource to the first cell, and

providing fixedly transport channel processing resource from the second set of hardware resource to the second cell.

In a particular embodiment there is provided a first set of cells and a second set of cells whereby the method comprises providing fixedly resource from the first set of hardware resource to the first set of cells and providing fixedly resource from the second set of hardware resource to the second set of cells.

In a preferable embodiment the base station is a shared base station, the use of which is shared between at least two different network operators. In this embodiment the first set of cells belong to a first network operator and the second set of cells belong to a second network operator, (and the first and second network operator are thus sharing the base station). In a particular embodiment the different cells are formed by using different frequencies (or frequency bands) for the different operators from the same BTS.

The different cells in the first set of cells and respectively in the second set of cells can be different sectors of a base station. This means that the base station is using narrowband antennae that create beams, i.e. sectors to different directions from the base station. For example to create a complete circle-like coverage area around the base station may require three or six different sectors. According to the invention each sector, or sub-cell, belonging to the first operator would get resource from the first set of hardware resource and each sector, or sub-cell, belonging to the second operator would get resource from the second set of hardware resource.

The base station can further include common hardware resource which can be allocated both to the first set of cells and to the second set of cells. This common hardware resource can be used for signaling relating to establishing a connection (e.g. a phone call) within any cell of the first and second set of cells. After a connection is set up a phone call within the first set of cells will be allocated hardware resource from the first set of hardware resource and a phone call within the second set of cells will be allocated hardware resource from the second set of hardware resource.

In one embodiment the division according to the invention of hardware resources can be time dependent, i.e. only take place at a certain time of day such as during high traffic hours.

The invention allows operators to have a guaranteed amount of processing capacity (hardware resource) from a shared base station, i.e. a base station that it shares with another operator.

In an embodiment of the invention there is intended by the processing capacity or hardware resource of the base station internal processing capacity which is achieved by internal hardware resource (implemented by electronics) for processing of signals at the base station. Especially, although not necessarily, the processing comprises base band signal processing such as channel coding and decoding. Also the processing may comprise transport channel related processing functions.

According to a second aspect of the invention there is provided a base station having at least a first transceiver forming a first cell and a second transceiver forming a second cell, wherein the base station comprises

a predetermined first set of hardware resource for processing of communication signals,

a predetermined second set of hardware resource for processing of communication signals,

means for providing fixedly transport channel processing resource from the first set of hardware resource to the first cell, and

means for providing fixedly transport channel processing resource from the second set of hardware resource to the second cell.

According to a third aspect of the invention there is provided a cellular radio network comprising at least two different core networks and one radio access network connected to each of the at least two core networks, the radio access network comprises a base station having at least a first transceiver forming a first cell and a second transceiver forming a second cell, wherein the base station comprises

a predetermined first set of hardware resource for processing of communication signals,

a predetermined second set of hardware resource for processing of communication signals,

means for providing fixedly resource from the first set of hardware resource to the first cell, and

means for providing fixedly resource from the second set of hardware resource to the second cell.

By the definition core network CN there is intended in 3G systems that there is both a the packet switched communication elements (such as SGSN) and the circuit switched communication elements (such as MSC), whereas a MSC (together with a GMSC) can stand for CS CN (circuit switched core network) and SGSN (together with a GGSN) can stand for PS CN (packet switched core network).

By processing of communication signals is meant data (signals) which are processed in the base station (i.e. data coming from the air interface towards the core network and data coming from the core network toward the air interface) but in practice the signals relate to communication within a particular cell, for which certain hardware resource is fixedly provided according to the invention.

In a particular embodiment the two different core networks belong to two different operators, whereby the embodiment comprises sharing the base station between the two different network operators. However, one single network operator could also have two different core networks between which the sharing can be made. Also, naturally a base station can be shared by more than two different operators, e.g. by 3, 4 or 5 operators, whereby the base station would have 3, 4 or 5 different sets of hardware resource, each provided fixedly for a cell of a corresponding operator.

Same embodiments apply to the second and third aspects of the invention as to the first aspect of the invention.

The invention is described in detail in the following with reference to enclosed figures, in which

FIG. 1 presents the system architecture of a 3G radio system,

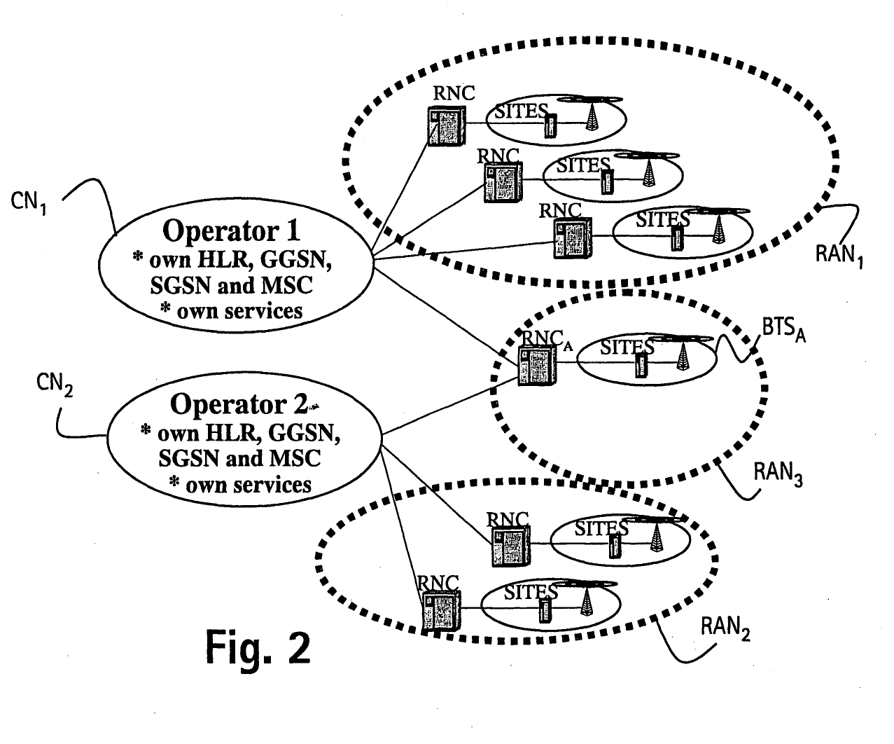

FIG. 2 presents the sharing of the a base station between two different operators,

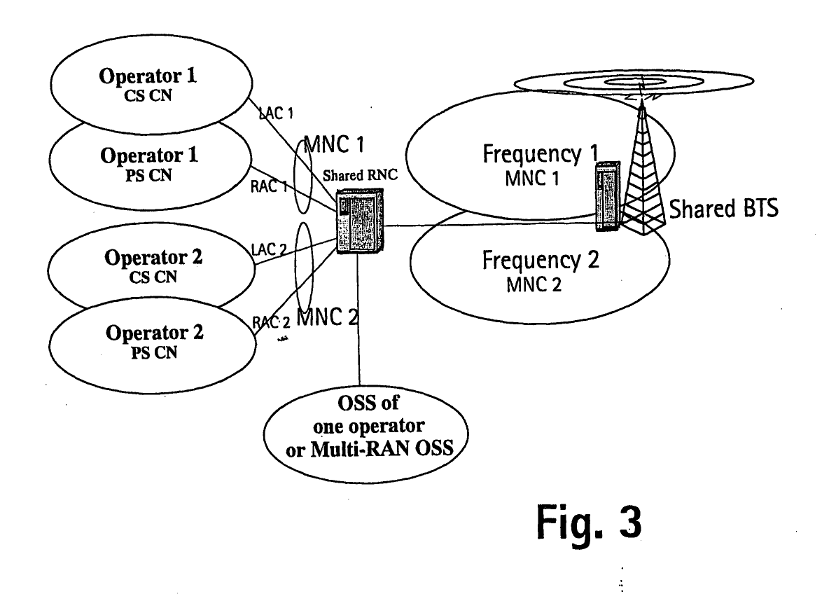

FIG. 3 presents the sharing of a base station between two core networks,

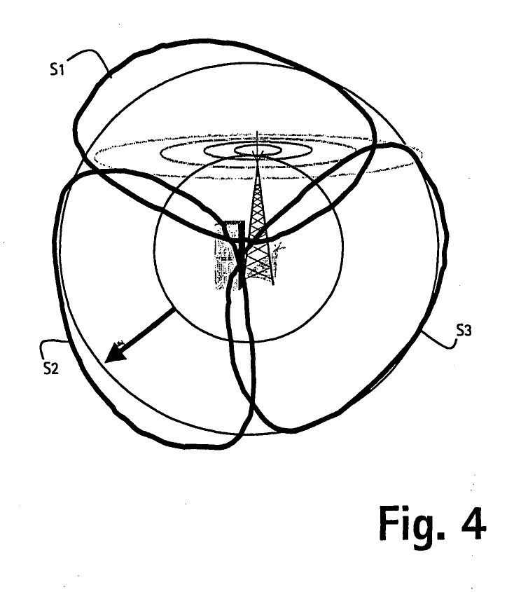

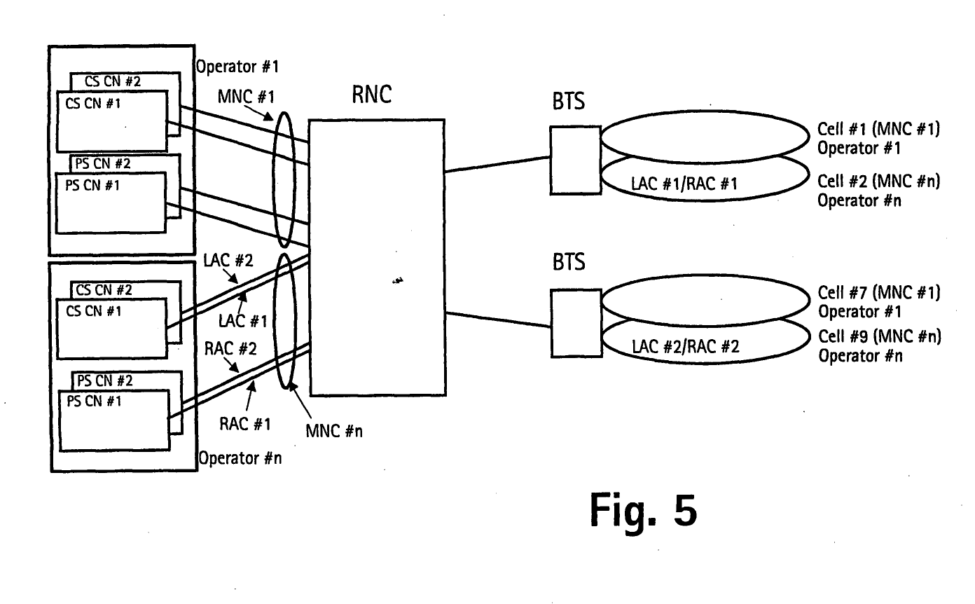

FIG. 4 presents sectors or smaller cells of a base station forming a complete bigger cell or coverage area of the base station,

FIG. 5 presents the routing of messages from a core network to shared base stations,

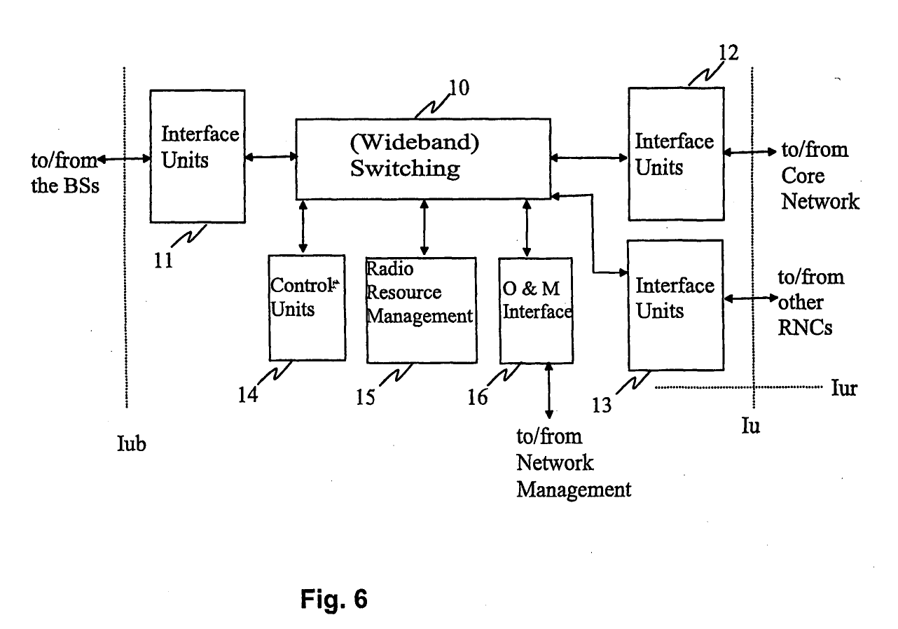

FIG. 6 presents a block diagram of a radio network controller,

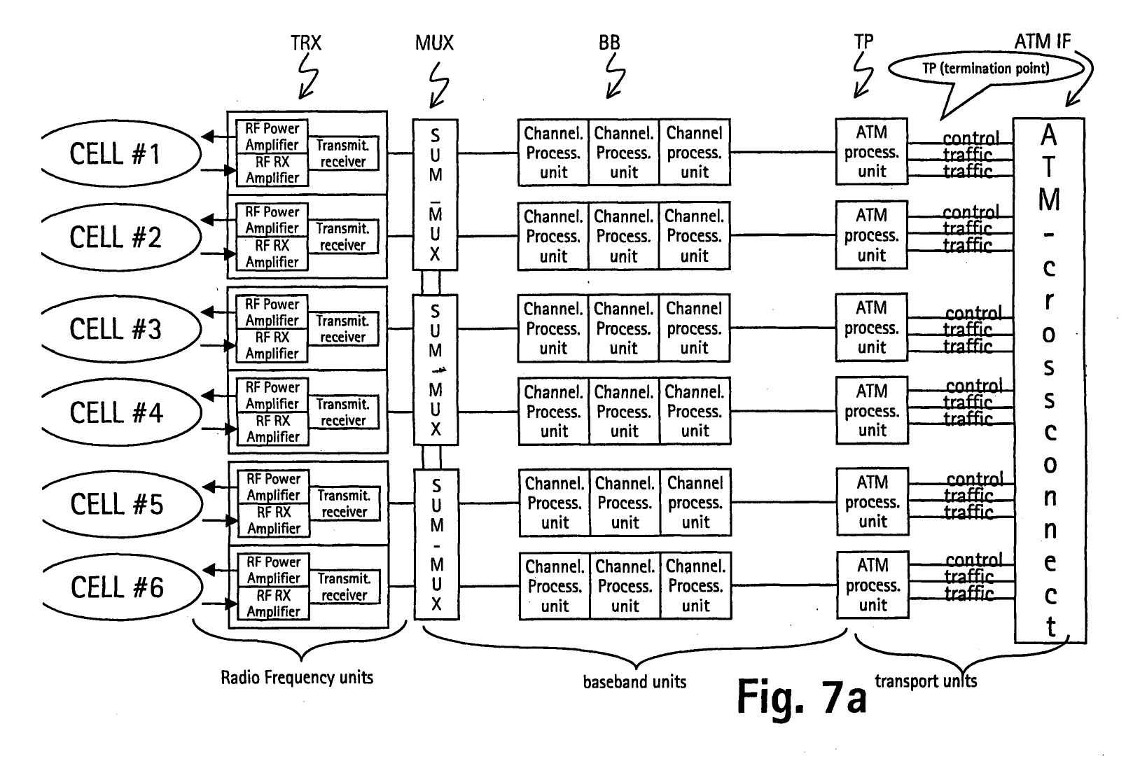

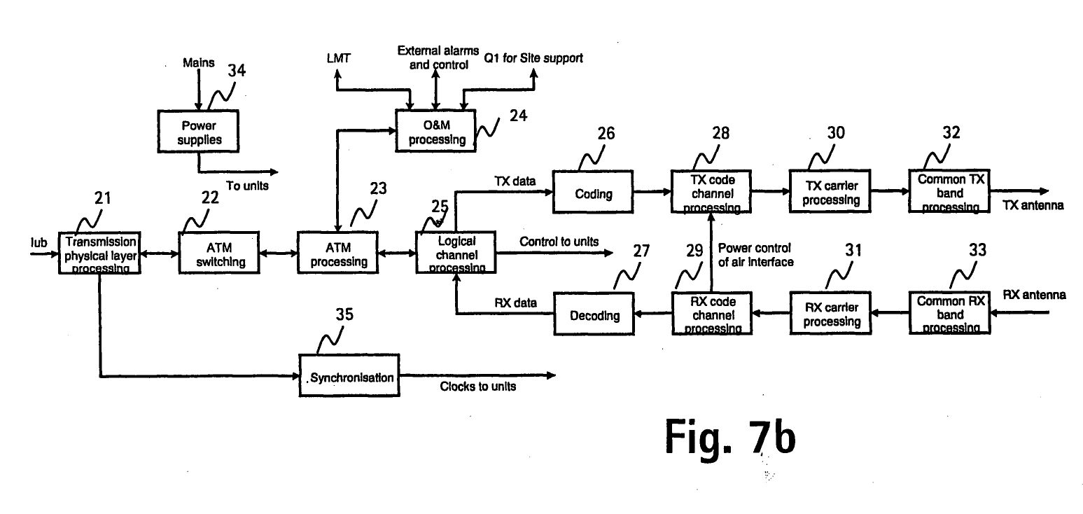

FIG. 7a presents a block diagram of a base station forming six cells (or sectors),

FIG. 7b presents a logical block diagram of a base station for a single cell,

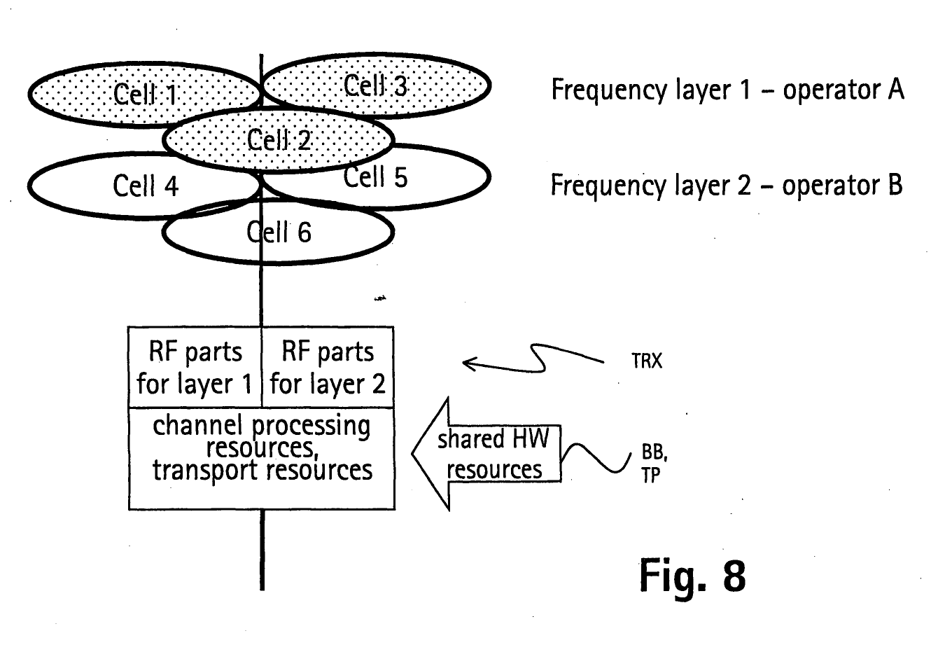

FIG. 8 presents a high level diagram of cells and resources of a base station,

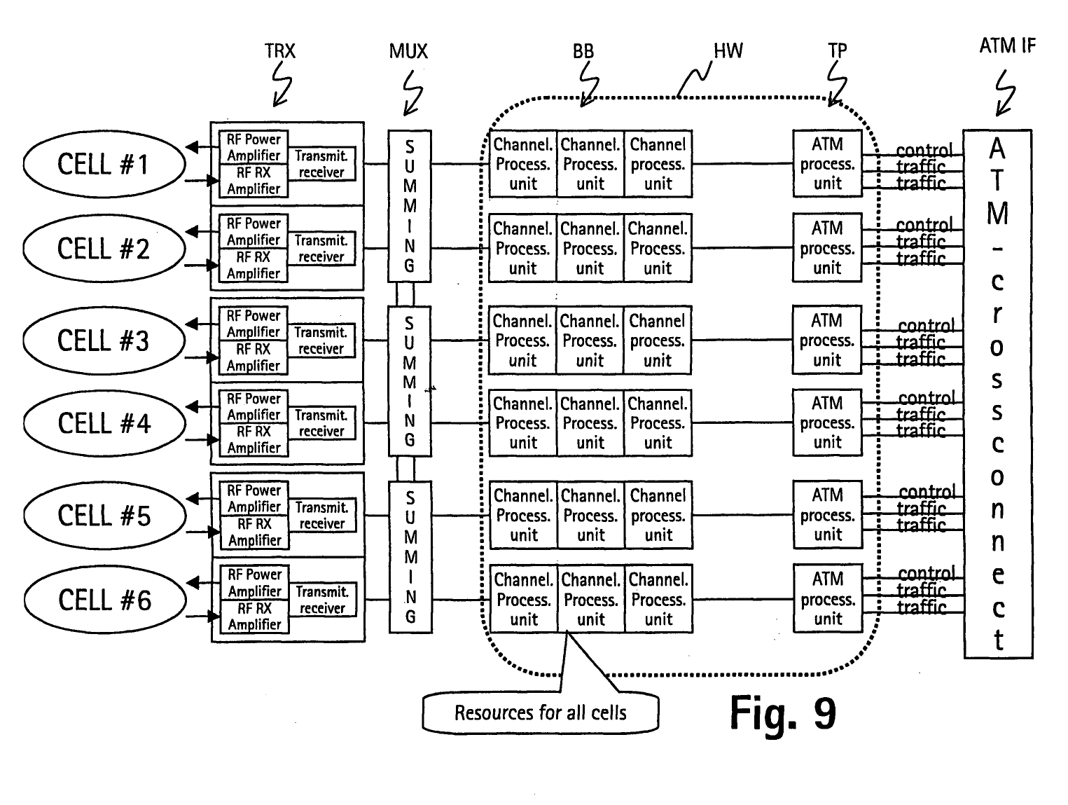

FIG. 9 presents the use of base station processing resource in a shared base station without the use of the present invention,

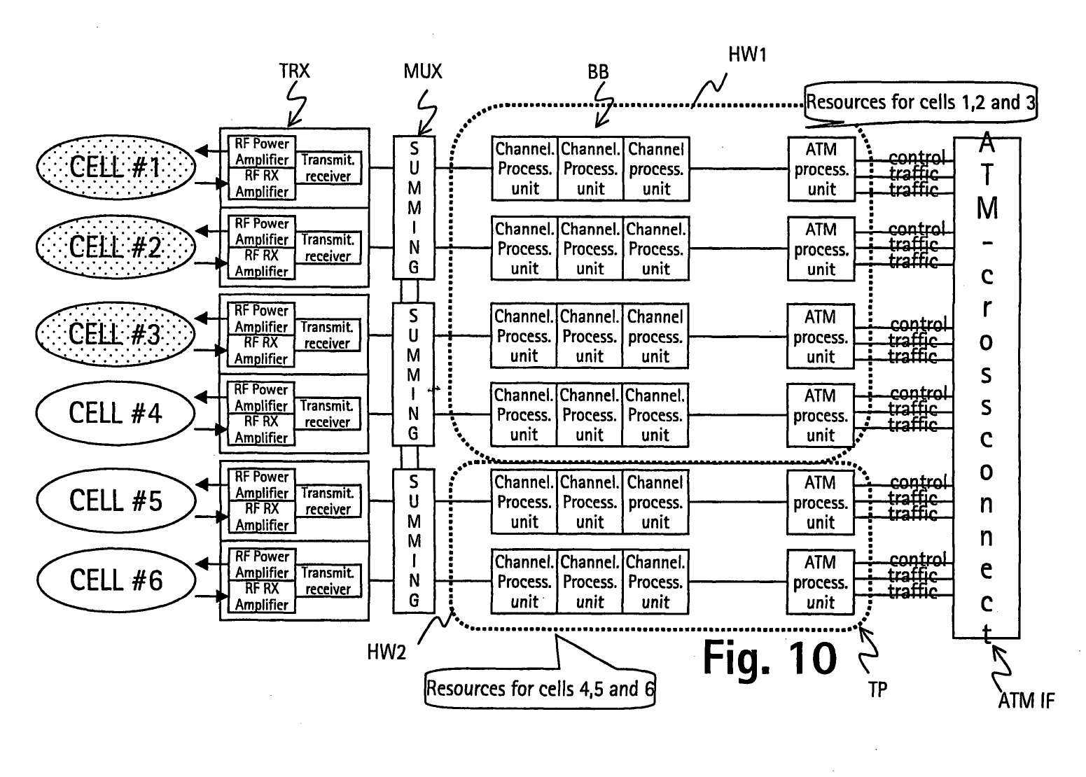

FIG. 10 presents an example of a shared base station according to the invention by a block diagram of the base station,

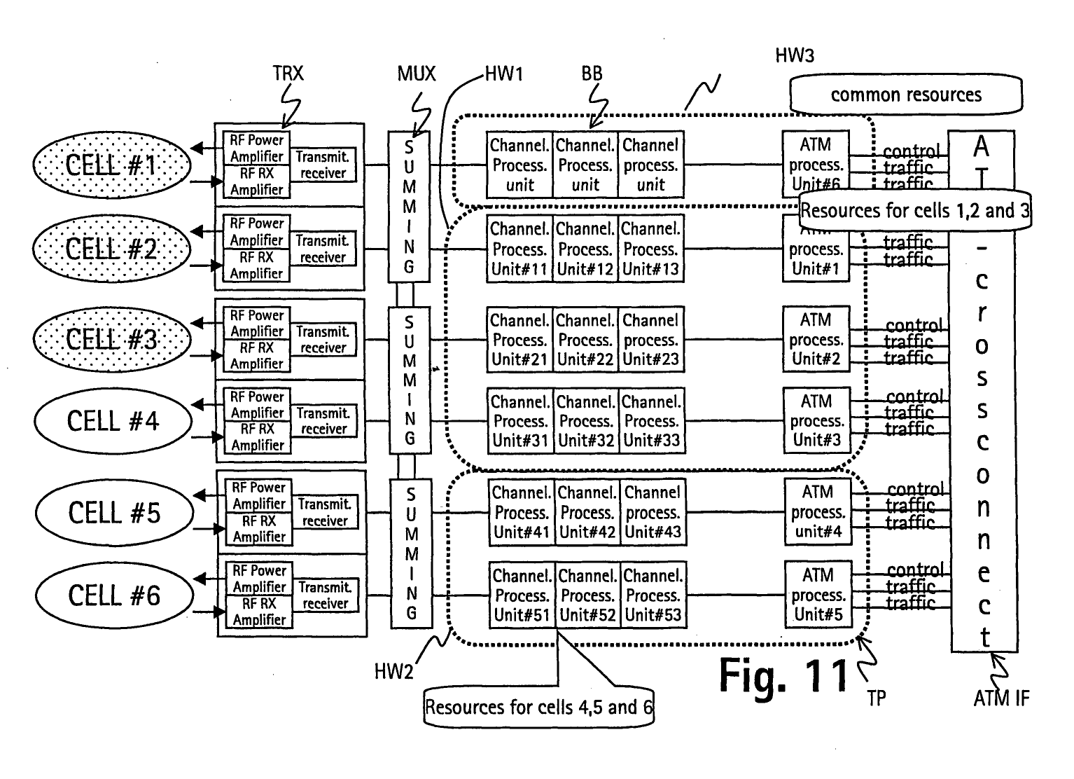

FIG. 11 presents another example of a shared base station according to the invention by a block diagram of the base station.

Referring now to FIG. 2 there is disclosed the idea of sharing a base station (and also sharing a RNC) between two operators. It is worth noting that the present invention concerns mainly a shared base station BTS, and it is not necessary for the invention to also share a RNC, and e.g. in a so called IP-RAN (internet Protocol RAN) there are no RNCs. The figure shows a core network CN₁ of a first operator (Operator 1), which includes network elements such as an own HLR, GGSN, SGSN, MSC and possible service elements (servers connected to the MSC and or GSN in a similar manner as a SM-SC, Short Message Service Centre, is connected to the MSC in the GSM network). Similarly there is a second core network CN₂ of a second operator (Operator 2), which likewise includes own network elements such as an own HLR, GGSN, SGSN, MSC and possible service elements. The core networks CN₁ and CN₂ are thus configured and include network elements in the same manner as known from 3G network plans and as shown in FIG. 1. Similar as shown in FIG. 1 there are in FIG. 2 radio access networks RAN₁, RAN₂, RAN₃ connected to the core networks CN₁, CN₂, where RAN₁ is connected to CN₁ in a known manner and RAN₂ is connected to CN₂ correspondingly. The sharing according to the invention is done in the third radio access network RAN₃, where both core networks CN₁ and CN₂ are connected thereto.

Thereby, in this example both operators and thus both core networks CN₁, CN₂ utilise (i.e. share) both the radio network controller RNC_{A} of RAN₃ and also the base station BTS_{A}.

A similar sharing could also be used when the two core networks CN₁, CN₂ belong to one and the same operator. As mentioned, there are so called IP-RANs (Internet Protocol Radio Access Networks) in which there are no RNCs. The present invention with BTS hardware resource management can equally well be used at BTSs of an IP-RAN as of a normal RAN (i.e. with RNCs). Also a shared BTS according to the invention can be used in a RAN, where each operator has their own RNCs.

The radio network shown in FIG. 2 is thus configured so that operators 1 and 2 can share RAN₃ (by having shared RNCs and shared BTSs) and each operator have dedicated own cells through which mobile stations can have access (establish a connection) to the network. This is shown more closely in FIG. 3. Each cell has its own MNC (Mobile Network Code) and MCC (Mobile Country Code) corresponding to the operator.

The differentiation between the two operators is based on MNC, and as shown in FIG. 3 MNC1 is used by Operator 1 and MNC2 is used by Operator 2. In practice this means that a shared RNC (such as RNC_{A} and RNC_{B}) has a preconfigured routing table which contains the MNC information and by using this information the messages are routed to appropriate operators core networks CN₁ and CN₂. The routing is based on a solution where a cell based determination has been made to corresponding core network CN elements of CN₁ and CN₂. The different cells are formed by using different frequencies for the different operators' cells from the same base station BTS. Thereby certain frequencies are determined to correspond to certain CN elements.

Referring now to FIG. 3 there is disclosed the principle of sharing a base station. The two different core network assemblies of each operator represent the circuit switched and packet switched portions of the core network. Thereby CS CN of Operator 1 represents the core network elements of Operator 1 in relation to circuit switched communications (i.e. the MSCs) and PS CN of Operator 1 represents the core network elements of Operator 1 in relation to packet switched communications (i.e. the GSNs). Likewise CS CN of Operator 2 represents the core network elements of Operator 2 in relation to circuit switched communications (i.e. the MSCs) and PS CN of Operator 2 represents the core network elements of Operator 2 in relation to packet switched communications (i.e. the GSNs). Each CN assembly is connected to the shared RNC. Division between the CN assemblies is based on LAC (Location Area Code) and RAC (Routing Area Code) so that the operator can determine in which CN traffic goes. Accordingly for circuit switched traffic of operator 1 a first LAC (LAC1) is used and for packet switched traffic of operator 1 a first RAC (RAC1) is used. Correspondingly for circuit switched traffic of operator 2 a second LAC (LAC2) is used and for packet switched traffic of operator 1 a second RAC (RAC2) is used. The shared base station (Shared BTS) uses a first frequency or frequency band (Frequency 1) for establishing a first cell (of operator 1) and uses a different second frequency or frequency band (Frequency 2) for establishing a second cell (of operator 2).

FIG. 4 shows the concept of how typically a complete cell or circle-like coverage area is formed in WCDMA networks by using narrowbeam antennae. In the example shown in FIG. 4 the full cell is formed by three different antennae creating a beam in different directions, each beam thereby forming an own sector S1, S2 and S3 or three own cells (or sub-cells) which together make the full cell. Typically each sector would use a different frequency or code to avoid collisions. Another full cell may comprise six different sectors which enable a broader coverage as the beam of an antenna with a narrower beam typically has a better gain and therefore the beam reaches further out. In the present invention the allocation of base station hardware resources is preferably done for each sector or cell (sub-cell), whereby with the invention a particular sector or cell is guaranteed a certain processing capacity from the base station.

The sharing of the base station can be done by each operator being provided with a similar whole full cell, i.e. having two similar cells that have all sectors S1, S2, S3 of the cell but use different frequencies (as was described above and shown in FIG. 3). Optionally only some but not necessarily all sectors of the base station would be used by each of the operators. Thereby the sharing may done sector-wise and different operators can even create different coverage in that e.g. operator 1 can use sectors S1 and S2 of the base station and operator 2 may use sectors S2 and S3 of the base station. Such a sector that is used only by one operator can be created only on one frequency, whereas shared sectors must created on several frequencies, i.e. on two frequencies (or different frequency bands within which each sector can further use a different frequency range) if two operators use the shared sector. The different sectors (sub-cells) can be identified by individual identifications, such as by a cell-id or e.g. according to which frequency the sector is given.

Two sharing determinations are included in a shared RNC which will described for understanding of how a shared RAN operates, although the present invention mainly concerns a shared BTS. For this purpose the RNC comprises a preconfigured routing table of operators using same physical RNC. Each operator has their own cells defined to by the Cell id, the MNC, and the MCC. Operators are identified with the MNC in the preconfigured routing table and the MNC is forwarded from the RRC (Radio Resource Control, which is a protocol between the mobile station MS and the RAN) to RANAP (Radio Access Network Application Protocol, which is a protocol over the lu interface) with the first Initial Direct Transfer message inside RNC. Thereby by linking the information on the RRC and RANAP and MNC a message from a particular base station can be transferred to the correct CN from RANAP. This allows the sharing of a RAN and therefore allows several operators to use one physical RNC. The protocols RRC and RANAP do not require any changes due to sharing a RAN, but the message routing is done by transferring the MNC and MCC inside the RNC.

The preconfigured routing table contains also an operator specific list of CN elements serving an area (a routing area and/or a location area depending of the traffic type). Each CN element has its own identification or signaling number based on which it is identified. With this list it is possible for the RNC to route the traffic to the appropriate CN element to serve a particular MS. The selection is done when a signalling connection is first established between the MS and the CN element. Only one CN element of the same type (Circuit Switched CS or Packet Switched PS) shall serve the MS at the same time. Accordingly CS and PS elements are identified separately and the CS and PS traffic is identified separately by CN domain IDs. When there exists several CNs of the same type (e.g. several PS CNs and/or several CS CNs as shown in FIG. 3) these are identified by codes LAC and RAC as was shown and described in connection with FIG. 3.

Routing of messages between the core networks CNs and the radio access network RAN is based on MCC (Mobile Country Code), MNC (Mobile Network Code), LAC (Location Area Code), RAC (Routing Area Code). This is disclosed in more detail in FIG. 5 and Table 1 below which shows an example of a routing table.

TABLE 1
>Operator #1 (MCC + MNC)#1
>>CN Domain Identity

| | |
|---|---|
| >>>CS | >>>>LAC #1 -> CS CN #1 |
| | >>>>LAC #N -> CS CN #n |
| >>>PS | >>>>RAC #1 -> PS CN #1 |
| | >>>>RAC #N -> PS CN #n |

>Operator #x (MCC + MNC)#X
>>CN Domain Identity

| | |
|---|---|
| >>>CS | >>>>LAC #9 -> CS CN #9 |
| | >>>>LAC #Z -> CS CN #z |
| >>>PS | >>>>RAC #6 -> PS CN #6 |
| | >>>>RAC #Y -> PS CN #y |

As shown in Table 1 circuit switched and packet switched traffic is identified separately by creating an allocation between the circuit switched CN elements and the LAC which identifies the CS traffic. Likewise an allocation is created between the packet switched CN elements and the RAC which identifies the PS traffic. Also above these the CN Domain Identity (CS and PS) is used to differentiate between circuit switched and packet switched traffic. Referring to Table 1 and FIG. 5 there is created an allocation between the circuit switched traffic of a particular cell (e.g. Cell #1) and the CS CN elements of Operator #1 by the definition >>>>LAC #1->CS CN #1. Likewise there is an allocation from cell #N to the CS CN elements of Operator #1 by the definition >>>>LAC #N->CS CN #n. In a similar manner for packet switched traffic there is an allocation from cell #1 to the PS CN elements of Operator #1 by the definition >>>>RAC #1->PS CN #1. Each data is linked to the operator codes (MCC+MNC)#1 of Operator #1. In this manner traffic between cell #1 shown in FIG. 5 to the relevant CN elements is routed correctly by the RNC. Thereby each operator #1 to #n (or #X) sends their own MNC (MNC#1 . . . MNC#n) to their subscribers. Thereby if a subscriber activates cell identification on his/her mobile station the cell id (or logo) of his/her own operator appears on the display. The MCC is used to route a call to the CN of the relevant country (in calls between two different countries). The MCC can particularly be utilized in cells around country boarders.

Further referring to FIG. 3, there is disclosed an Operating Sub-System element (OSS) in connection with the RNC. The OSS is also known by the term NMS (Network Management System), that is used to manage the network by managing features such as access rights, user ID management, security and monitors especially the RANs by collecting alarms and key performance indicators (KPIs) from RAN equipment (from RNCs). The different operators may have separate OSS equipment (an OSS is typically implemented as one or several servers) or may share a common OSS (or may agree that the OSS of one of the operators is used to manage the shared RAN). If one of the operators' OSS is used then the RAN maintenance is done by that operator's OSS and other operators can have access to see their own cells (e.g. through a direct connection from another operator's OSS to the monitoring OSS).

Operators can agree and co-operate on how to divide costs, cells, transmission and operationing of a multi-operator RAN. These kind of issues are handled in the OSS which includes configurable parameters.

The RAN needs to be synchronized with the CNs. In practice this can be implemented by agreeing to which of the at least two different CNs that the shared RAN is synchronized to. Optionally the two CNs may be mutually clock synchronized.

FIG. 6 presents a block diagram of a radio network controller RNC. Logically the RNC is composed of only two parts, i.e. a broadband switching block 10 and controlling entities, i.e. Control Units block 14, Radio Resource Management block 15, and Operation and Management block 16 (from where there is a connection to the OSS, i.e to the NMS). On the lub interface end the RNC comprises a first Interface Unit 11, and on the lu interface end the RNC comprises a second Interface Unit 12. Further there is a third Interface Unit 13 for connections from the RNC to other RNCs. The routing table of the RNC is implemented in the Control Units block 14, which to its hardware implementation is like a computer. Therefore as is known a table, such as the one shown in Table 1 can be implemented as a program in the Control Units block 14, which implements all RNC control functionalities and the RRC protocol as well as the RANAP protocol and handles the MNC and MCC, as well as LAC and RAC.

FIG. 7a presents a block diagram of a base station for forming six different cells CELL#1-CELL#6. Starting from the right there is an ATM interface for interfacing from the base station towards the network, e.g. over the lub interface to the RNC (see FIG. 1). Via the ATM interface ATM IF there are traffic and control connections to ATM processing units TP. Further the base station has several Channel Processing units BB performing base band signal processing such as coding and decoding. These Channel Processing Units form part of the hardware resource of the base station that is allocated to a cell when there is communication in the cell, e.g. a phone call. For base band processing of communication within a cell of the cells CELL#1-CELL#6 one Channel Processing unit of all the units BB is allocated. Normally the base band hardware resources BB of the base station are allocated based on contention, whereby one of the cells might not get the base station resource capacity as needed for calls within that cell. This could be a problem with shared base stations in that one operator could get more capacity than the other. Also, from an implementation point of view typically a Channel Processing unit could be implemented in the form of a printed circuit board (naturally with the necessary electronic components) which can be added by connecting more such printed circuit boards to a mother board. This is illustrated in the figure in form of several Channel Processing unit blocks. In a shared base station it is possible that one operator acquires more such PCBs (i.e. BB units) than the other, but yet could possibly not get more hardware resource capacity as the BB units would normally be allocated on contention basis for connections established within the different cells CELL#1-CELL#6 of the base station. The transfer of signals between a particular cell of the cells CELL#1-CELL#6 and a particular allocated Channel Processing unit takes place via summing and multiplexer units MUX that multiplex the signals to and from the allocated units BB. The signals go through RF transceivers TRX, which typically include means for modulating the base band signal to radio frequency and rf amplifiers for amplifying the signal before transmission. Similarly in reception the signals are typically first (filtered and) amplified and then demodulated. Signals are transmitted and received to/from the cell on a certain frequency via an antenna (not shown, but typically each TRX would include or be connected to its own antenna).

FIG. 7b shows a logical block diagram of a typical base station for a 3G network (using WCDMA). Here merely the logical functions are illustrated without considering how many cells the base station will establish. The logical functions of each logical block 33 can be found in the 3G standard specifications. Compared to FIG. 7a there are corresponding to ATM IF and TP units a functional block 21 for transmission physical layer processing, and ATM switching functionality 22 and an ATM processing unit 23. Further comparing to FIG. 7a the Channel Processing unit performs the functionality and connections of a Coding block 26, Decoding block 27, TX code channel processing 28 and RX code channel processing 29. The base station further includes a Logical channel processing block 25 for interfacing and control of traffic between the Channel Processing units BB and the ATM processing blocks 23 (or TP in FIG. 7a). The functionality of the TRX blocks in FIG. 7a corresponds to blocks 30-33 in FIG. 7b, where block 30 is a TX carrier processing block, block 31 is a RX carrier processing block, block 32 is a Common TX band processing block and block 33 is a Common RX band processing block. The connection to the antenna is from blocks 32 and 33. Further the base station has a power supply unit 34 and a synchronization block 35 for synchronising and providing clock signals to the different base station functional units (such as units 26-33). Further typically a base station has an operation and management unit 24 which can e.g. include a user interface for controlling and programming the base station.

Concerning blocks 26-29 which make one Channel Processing unit BB and are of particular interest in the invention, the functionalities of the Coding 26 and Decoding blocks for a 3G base station (or Node B as it is called in 3G standardization documents) have been defined in 3GPP standardization document TS 25.212 where Release 4 is from December 2000. Other functionalities of the Channel Processing unit blocks 26-29 have been defined in documents TS 25.211, TS 25.213, TS 25.214 and TS 25.215 where the TX and RX code channel processing is defined under headings Physical Channel.

Turning now to FIG. 8 presenting on a high level a typical sharing situation of a shared base station, where a first operator A and a second operator B are sharing the same base station. Both operators have a sectorised cell of e.g. 3 sectors (similarly as shown in FIG. 4) and use an own frequency range or frequency layer. In this example operator A has cells 1-3 (or sectors 1-3 on a first frequency layer 1) and operator B has cells 4-6 (or sectors 4-6 on a second frequency layer 2). For each cell the base station has own RF parts TRX, whereas for base band and transport channel processing resources are allocated from a common hardware resource BB, TP. This is illustrated in more detail in FIG. 9 which is identical (and the description of which is identical) with that of FIG. 7a, where there is a dotted line around the common hardware (or processing) resources for the different cells (or for data coming from and going to each cell) of the base station indicated by reference HW. As described in connection with FIG. 7a the common hardware resource HW includes Channel Processing units BB (performing functions such as channel coding and decoding, power control and retransmissions) and ATM processing units TP. The ATM processing unit can also be called, or they at least include and implement the functionality of the so called Traffic Termination Point TTP which is defined in 3GPP document TS 25.430 e.g. in Release 1999 Version 3.5.0 from March 2001.

An example of a basic idea of the present invention is illustrated in FIG. 10, which is identical (and the description of which is identical) with that of FIG. 9 except that the hardware resources HW have been divided into two different dedicated portions HW1 and HW2, thereby forming a first set of hardware resource HW1 and a second set of hardware resource HW2. Here the Channel Processing units BB and ATM processing units TP (or TTPs) of the first set of hardware resource HW1 are fixedly provided as a resource for cells CELL#1-CELL#3 and the Channel Processing units BB and ATM processing units TP (or TTPs) of the second set of hardware resource HW2 are fixedly provided as a resource for cells CELL#4-CELL#6. Thereby for communication in any of cells CELL#1-CELL#3 Channel Processing units and ATM processing units from the first set of hardware resource HW1 are allocated. Correspondingly for communication in any of cells CELL#4-CELL#6 Channel Processing units and ATM processing units from the second set of hardware resource HW2 are allocated. If cells CELL#1-CELL#3 belong to a first operator A and if cells CELL#4-CELL#6 belong to a second operator B then operator A is guaranteed hardware resource (i.e. transport channel and baseband processing capacity) from the first set of hardware resource HW1 and operator B is guaranteed hardware resource (i.e. transport channel and baseband processing capacity) from the second set of hardware resource HW2.

An alternative to FIG. 10 is presented in FIG. 11 which is identical (and the description of which is identical) with that of FIG. 10 except that the hardware resources HW have been divided into three different dedicated portions HW1, HW2 and HW3, thereby forming a first set of hardware resource HW1 and a second set of hardware resource HW2 and a third common set of hardware resource HW3. The description and use of the first and second set of hardware resource HW1 and HW2 is the same as in FIG. 10, but before establishing a connection within any of the cells there is call establishment signalling taking place. This is always directed through the ATM processing unit TP of the third set of hardware resource HW3 and through one of the Channel Processing units BB of the third set of hardware resource HW3 irregardless of which cell the connection or call establishment concerns. Once the call or connection has been established the processing of the information on that particular connection is handled in one of the Channel Processing units and ATM processing unit of the first HW1 or second HW2 set of hardware resource depending on whether the connection or call is in cells CELL#1-CELL#3 or cells CELL#4-CELL#6.

Naturally the examples of FIGS. 10 and 11 can comprise more that two different dedicated sets of hardware resource than just HW1 and HW2 using the same idea. Thereby for example more than to operators (such as 3, 4 or 5 operators) can share the same base station but can guarantee certain hardware resources for themselves.

The fixed allocation of hardware resources for a certain cell (such as cell 1) from a certain set of hardware resources (such as from HW1) can be implemented in the base station by a correlation or linking table linking together a certain cell identification identifying the particular cell and an identification of a particular Traffic Termination Point TTP (or ATM processing unit as shown in the Figures). This first table, Table 2 could look following with reference to FIG. 11:

| Cell ID | TTP ID |
|---|---|
| Cell #1 | ATM units #1, #2 or #3 |
| Cell #2 | ATM units #1, #2 or #3 |
| Cell #3 | ATM units #1, #2 or #3 |
| Cell #4 | ATM units #4 or #5 |
| Cell #5 | ATM units #4 or #5 |
| Cell #6 | ATM units #4 or #5 |

This table is preferably stored in the common TTP, i.e. in ATM processing unit #6 (see FIG. 11) and indicates e.g. that Cell#1 can communicate via ATM processing units #1, #2 or #3. As call or connection setup signalling, such as the Radio Link Setup Request message (which includes the Cell ID) as defined in 3GPP standardization document (TS 25.433) goes through this common TTP unit (ATM processing unit #6) the allocation of a certain resource to a certain cell can be done in this TTP. It is sufficient to link the TTP ID to the Cell ID since once a call is established it will be handled through that particular TTP which is defined in Table 2 for that cell. An alternative way of linking particular cells to particular TTPs could be according to a certain frequency (as the cells of a certain operator would be using certain frequencies), whereby certain frequencies or frequency bands would be linked to particular TTPs

Further the particular Channel Processing units that can be used for processing of communication of a certain cell is defined in another table, Table 3 which is held at each TTP (i.e. at each ATM processing unit). When the call is established and it is directed to a particular ATM processing unit (e.g. ATM unit #1 for Cell #1) the Table 3 stored at that particular ATM processing unit (i.e. at that particular TTP) defines which Channel Processing unit that ATM unit can use (or it can define the Channel Processing units of all TTPs as shown below in the exemplary Table 3).

This second table, Table 3 could look following at the TTP with reference ATM unit#3 and to FIG. 11:

| | Channel Processing unit |
|---|---|
| TTP ID | (CPu) |
| ATM unit #1 | CPu #11, #12 or #13 |
| ATM unit #2 | CPu #21, #22 or #23 |
| ATM unit #3 | CPu #31, #32 or #33 |
| ATM unit #4 | CPu #41, #42 or #43 |
| ATM unit #5 | CPu #51, #52 or #53 |

The above exemplary Table 3 can be stored at every TTP (at every ATM processing unit #1-#5).

In accordance with the above and the structure of the base station as shown in FIG. 11, when the Radio Network Controller RNC requests the base station BTS to setup a radio link with Radio Link Setup Request message (that includes the Cell ID) the ATM processing unit#6 to which the message goes allocates a particular ATM processing unit according to Table 2 and further the particular Channel Processing unit is allocated according to Table 3 stored at the particular allocated ATM processing unit.

The above has been an introduction of the realization of the invention and its embodiments using examples. It is self evident to persons skilled in the art that the invention is not limited to the details of the above presented examples and that the invention can be realized also in other embodiments without deviating from the characteristics of the invention. The presented embodiments should be regarded as illustrating but not limiting. Thus the possibilities to realize and use the invention are limited only by the enclosed claims. Thus different embodiments of the invention specified by the claims, also equivalent embodiments, are included in the scope of the invention.

The invention can guarantee a certain operator of a shared base station a certain base band processing capacity or a certain hardware resource capacity. The fixed resource division can be fixed all the time or alternatively only at certain times, e.g. only during high traffic hours (which could be defined in the common TTP through which call setup signalling is transferred) but at other times any hardware resource could be allocated to any cell of a shared base station. Also the invention could be used in a base station which is not shared but owned by a single operator alone. In this case one or more cells could be more valuable than other cells of that base station and the operator might want to guarantee certain resources for those more valuable cells. For example an important building could be located within a particular cell (sector) and to guarantee a low failure of connections that cell could be fixedly allocated a high number of hardware resource from the base station.

1. A method for managing resources in a cellular radio network having a base station forming at least a first cell (CELL#1) and a second cell (CELL#4), the method comprising
having a predetermined first set of hardware resource (HW1) at the base station,
having a predetermined second set of hardware resource (HW2) at the base station,
providing fixedly transport channel processing resource from the first set of hardware resource (HW1) to the first cell (CELL#1), and
providing fixedly transport channel processing resource from the second set of hardware resource (HW2) to the second cell (CELL#4).

2. A method according to claim 1, wherein the method comprises
forming a first set of cells (CELL#1-CELL#3) and a second set of cells (CELL#4-CELL#6) from the base station,
providing fixedly transport channel processing resource from the first set of hardware resource (HW1) to the first set of cells, and
providing fixedly transport channel processing resource from the second set of hardware resource (HW2) to the second set of cells.

3. A method according to claim 1 or 2, wherein the method comprises sharing the base station (BTS) between at least two different core networks (CN₁, CN₂).

4. A method according to claim 1, wherein the first cell is used by a first network operator and the second cell is used by a second network operator.

5. A method according to claim 2, wherein the first set of cells is used by a first network operator and the second set of cells is used by a second network operator.

6. A method according to claim 1, wherein forming at least a first and a second cell comprises using a first frequency to establish a first cell and using a second frequency to establish a second cell.

7. A method according to claim 2, wherein the method comprises forming a base station coverage area by creating at least three different cells, and wherein the method comprises providing fixedly transport channel processing resource from the same set of hardware resource (HW1) to any of the at least three different cells.

8. A method according to claim 1, wherein the method comprises storing linkage data linking the first cell with the first set of hardware resource and linking the second cell with the second set of hardware resource.

9. A method according to claim 8, wherein the method comprises linking the first and second cell with the respective set of hardware resource according to a cell identification data.

10. A method according to claim 8, wherein the method comprises linking the first and second cell with the respective set of hardware resource according to a frequency used by the first and second cell respectively.

11. A method according to claim 1, wherein the method comprises
having a predetermined third set of hardware resource (HW3) at the base station,
providing fixedly a common resource from the third set of hardware resource (HW3) to the first cell (CELL#1) and to the second cell (CELL#4) for processing of call or connection establishment signaling, and
once the call or connection has been established the processing of information on that call or connection is handled by the first (HW1) or the second (HW2) set of hardware resource depending on whether the connection or call is in the first (CELL#1) or the second (CELL#4) cell.

12. A method according to any previous claim, wherein the hardware resource comprises base band processing capacity of the base station.

13. A method according to claim 11, wherein the base band processing capacity comprises channel coding and decoding.

14. A method according to claim 1, wherein the method comprises performing the steps of fixedly providing resource at certain times only.

15. A base station having at least a first transceiver forming a first cell (CELL#1) and a second transceiver forming a second cell (CELL#4), wherein the base station comprises
a predetermined first set of hardware resource (HW1) for processing of communication signals,
a predetermined second set of hardware resource (HW2) for processing of communication signals,
means (Table 2, Table 3, ATM unit#6) for providing fixedly transport channel processing resource from the first set of hardware resource (HW1) to the first cell, and
means (Table 2, Table 3, ATM unit#6) for providing fixedly transport channel processing resource from the second set of hardware resource (HW2) to the second cell.

16. A base station according to claim 15, wherein the first transceiver is configured to transceive at a first frequency to form the first cell and the second transceiver is configured to transceive at a second frequency to form the second cell.

17. A base station according to claim 15, wherein the base station comprises
a first set of transceivers for forming a first set of cells (CELL#1-CELL#3),
a second set of transceivers for forming a second set of cells (CELL#4-CELL#6),
means (Table 2, Table 3, ATM unit#6) for providing fixedly transport channel processing resource from the first set of hardware resource (HW1) to the first set of cells, and
means (Table 2, Table 3, ATM unit#6) for providing fixedly transport channel processing resource from the second set of hardware resource (HW2) to the second set of cells.

18. A base station according to claim 15, wherein the base station is configured to be operatively connected to at least two different core networks (CN₁, CN₂).

19. A base station according to claim 15, wherein the base station is configured to be operatively connected to a first core network (CN₁) operated by a first network operator and to a second core network (CN₂) operated by a second network operator, whereby the base station is further configured to establish the first cell (CELL#1) for the first network operator and the second cell (CELL#4) for the second network operator.

20. A base station according to claim 15, wherein the base station is configured to be operatively connected to a first core network (CN₁) operated by a first network operator and to a second core network (CN₂) operated by a second network operator, whereby the base station is further configured to establish the first set of cells (CELL#1-CELL#3) for the first network operator and the second set of cells (CELL#4-CELL#6) for the second network operator.

21. A base station according to claim 15, wherein the base station comprises means (TTP, ATM unit#6) for storing linkage data (Table 2) linking the first cell with the first set of hardware resource (HW1) and linking the second cell with the second set of hardware resource (HW2).

22. A base station according to claim 21, wherein the means (TTP, ATM unit#6) for storing linkage data (Table 2) comprises data for linking the first and second cell with the respective set of hardware resource according to a cell identification data.

23. A base station according to claim 21, wherein the means (TTP, ATM unit#6) for storing linkage data (Table 2) comprises data for linking the first and second cell with the respective set of hardware resource according to a frequency used by the first and second cell respectively.

24. A base station according to claim 15, wherein the base station further comprises
a predetermined third set of hardware resource (HW3) at the base station,
a common resource from the third set of hardware resource (HW3) to the first cell (CELL#1) and to the second cell (CELL#4) for processing of call or connection establishment signaling, and
the base station being configured to process information on that call or connection in the first (HW1) or the second (HW2) set of hardware resource depending on whether the connection or call is in the first (CELL#1) or the second (CELL#4) cell.

25. A base station according to any of claims 15 to 24, wherein the first and the second set of hardware resource (HW1, HW2) comprises base band processing units of the base station.

26. A base station according to claim 25, wherein the base band processing unit comprises a channel coder and decoder.

27. A cellular radio network comprising at least two different core networks (CN1, CN2) and one radio access network connected to each of the at least two core networks, the radio access network comprises a base station (BTS) having at least a first transceiver forming a first cell (CELL#1) and a second transceiver forming a second cell (CELL#4), wherein the base station comprises
a predetermined first set of hardware resource (HW1) for processing of communication signals,
a predetermined second set of hardware resource (HW2) for processing of communication signals,
means (Table 2, Table 3, ATM unit#6) for providing fixedly transport channel processing resource from the first set of hardware resource (HW1) to the first cell, and
means (Table 2, Table 3, ATM unit#6) for providing fixedly transport channel processing resource from the second set of hardware resource (HW2) to the second cell.

28. A cellular radio network according to claim 27, wherein the base station further comprises
a predetermined third set of hardware resource (HW3) at the base station,
a common resource from the third set of hardware resource (HW3) to the first cell (CELL#1) and to the second cell (CELL#4) for processing of call or connection establishment signaling, and
the base station being configured to process information on that call or connection in the first (HW1) or the second (HW2) set of hardware resource depending on whether the connection or call is in the first (CELL#1) or the second (CELL#4) cell.
